(19) United States
(12) Patent Application Publication
(10) Pub. No.: US 2016/0260336 A1
(43) Pub. Date: Sep. 8, 2016

(54) SYSTEMS AND METHODS FOR COLLATING COURSE ACTIVITIES FROM A PLURALITY OF COURSES INTO A PERSONAL LEARNING STREAM

(71) Applicant: D2L Corporation, Kitchener (CA)

(72) Inventor: Kenneth Chapman, Kitchener (CA)

(73) Assignee: D2L Corporation, Kitchener (CA)

(21) Appl. No.: 14/636,604

(22) Filed: Mar. 3, 2015

(51) Int. Cl. G09B 5/00; G09B 7/00

(52) U.S. Cl. CPC G09B 5/00; G09B 7/00

(57) ABSTRACT

There are provided methods and electronic learning systems for collating course activities from a plurality of courses into a personal learning stream. The method comprises the steps of selecting a primary course activity associated with a primary course within the plurality of courses, selecting a primary learning outcome associated with the primary course activity, identifying other course activities that are associated with courses within the plurality of courses and having a learning outcome similar to the primary learning outcome, and joining the primary course activity and other course activities into an activity stream. A pacing guide may be created from at least one pacing activity associated with the primary learning outcome, and the pacing guide may then be merged with the activity stream. The personal learning stream may be graphically represented on a calendar.

### TECHNICAL FIELD

The embodiments disclosed herein relate to electronic learning systems and methods, and, in particular to systems and methods for collating course activities from a plurality of courses into a personal learning stream.

### INTRODUCTION

Electronic learning (also called e-Learning or eLearning) generally refers to education or learning where users engage in education related activities using computers and other computer devices. For example, users may enroll or participate in a course or program of study offered by an educational institution or other organizations (e.g. a college, university, grade school, a business or a governmental organization) through a web interface that is accessible over the Internet. Similarly, users may receive assignments electronically, participate in group work and projects by collaborating online, and be graded based on assignments and examinations that are submitted using an electronic drop box.

An electronic learning system may be used to facilitate electronic learning. The electronic learning system contains a plurality of software and hardware components necessary to implement various features of electronic learning. For example, such features may include: use of electronic learning materials (e.g. handouts, textbooks, etc.), web-casting of live or recorded lectures, interaction through virtual chat-rooms or discussion boards, and performing web-based presentations. The users may access such features through a centralized electronic learning environment.

In many typical electronic learning scenarios, a student or learner may partake in one or more courses over a period of time. Each course in and of itself, as well as multiple concurrent courses together, may involve more than one learning outcome, activities, and challenges for a particular student. These challenges may vary significantly from one student to another. As such, for any given student, a somewhat random or disorganized presentation of individual course activities such as exams and assignments may create inefficiencies, since a student may focus on one exam that is scheduled prior to a second exam, therefore sacrificing performance on the second exam, when, in fact, the student is inherently weaker in the subject matter of the second exam, and therefore should have started studying for the second exam before starting to study for the second exam. Current electronic learning systems to do enable students to prioritize course activities and set study plans accordingly based on perceived weaknesses.

Furthermore, current electronic learning systems do not provide for the ability to collaborate studying and preparation activities from more than one course (or more than one course activity within a single course) based on common learning outcomes. Because of this, current electronic learning systems guide students towards an inefficient study or learning strategy, since they may study similar materials independently between two courses when they would otherwise have benefited from studying they similar materials from two different courses together.

Accordingly, there is a need for improved electronic learning systems and methods that address at least some of these concerns.

### SUMMARY

According to one aspect, there is provided a method for collating course activities from a plurality of courses into a personal learning stream. The method comprises the steps of: selecting a primary course activity associated with a primary course within the plurality of courses; selecting a primary learning outcome associated with the primary course activity; identifying other course activities that are associated with a learning outcome similar to the primary learning outcome, the other activities being associated with courses within the plurality of courses; and, joining the primary course activity and other course activities into an activity stream.

According to some embodiments, the method can further comprise the steps of: creating a pacing guide from at least one pacing activity, the at least one pacing activity being associated with the primary learning outcome; and, merging the pacing guide with the activity stream. In some cases, the method may be performed wherein no other course activities are identified and no other course activities are joined with the primary course activity into the activity stream.

According to some embodiments, any one of the number of pacing activities, the duration of time allotted for the pacing activities, and the period of the pacing guide may be determined by a learner proficiency score associated with the primary learning outcome, or may be determined proportionally to the learner proficiency score associated with the primary learning outcome, or determined by a grade-weight associated with the primary course activity, or determined by a proximity between a date of the primary course activity and a date of at least one of the other course activities.

According to some embodiments, the resources associated with the other course activities may be listed together with the resources associated with the primary course activity. Furthermore, the resources associated with a pacing activity may be listed together with the resources associated with the primary course activity.

According to some embodiments, a personal learning stream may be graphically represented on a calendar.

According to another aspect, there is provided an electronic learning system for collating course activities from a plurality of courses into a personal learning stream. The system comprises a display and at least one processor operatively coupled to the display.

The processor is configured for selecting a primary course activity associated with a primary course within the plurality of courses, selecting a primary learning outcome associated with the primary course activity, identifying other course activities that are associated with a learning outcome similar to the primary learning outcome (the other activities being associated with courses within the plurality of courses), and joining the primary course activity and other course activities into an activity stream.

According to some embodiments, the processor may be further configured for creating a pacing guide from at least one pacing activity (the at least one pacing activity being associated with the primary learning outcome), and merging the pacing guide with the activity stream. In some cases, no other course activities may be identified, and no other course activities may be joined with the primary course activity into the activity stream.

According to some embodiments, any one of the number of pacing activities, duration of time allotted for the pacing activities, and the period of the pacing guide may be determined by a learner proficiency score associated with the primary learning outcome, or may be determined proportionally to the learner proficiency score associated with the primary learning outcome, or may be determined by a grade-weight associated with the primary course activity, or may be determined by a proximity between a date of the primary course activity and a date of at least one of the other course activities.

### BRIEF DESCRIPTION OF THE DRAWINGS

The drawings included herewith are for illustrating various examples of articles, methods, and apparatuses of the present specification. In the drawings:

FIG. 1 is a schematic diagram of an electronic learning system;

FIG. 2 is a pictorial representation of course-activity schedules for four example courses;

FIG. 3 is a pictorial representation of course-activity schedules showing associated learning outcomes, according to some embodiments;

FIG. 4 is a block diagram showing a sample activity stream and personal learning stream, according to some embodiments;

FIG. 5 is a block diagram showing a sample pacing guide and personal learning stream, according to some embodiments;

FIG. 6 is a block diagram showing a personal learning stream comprising an activity stream and a pacing guide, according to some embodiments;

FIG. 7 is a flow chart of a method for collating course activities from a plurality of courses into a person a learning stream, according to some embodiments;

FIG. 8 is a flow chart of a method for collating course activities from a plurality of courses into a person learning stream, according to other embodiments;

FIG. 9 is a flow chart of a method for collating course activities from a plurality of courses into a person learning stream, according to other embodiments; and,

FIG. 10 is a flow chart of a method for collating course activities from a plurality of courses into a person learning stream, according to other embodiments;

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed below that is not claimed in this document may be the subject matter of another protective instrument, for example, a continuing patent application, and the applicants, inventors or owners do not intend to abandon, disclaim or dedicate to the public any such invention by its disclosure in this document.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a mainframe computer, server, personal computer, laptop, personal data assistant, or cellular telephone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

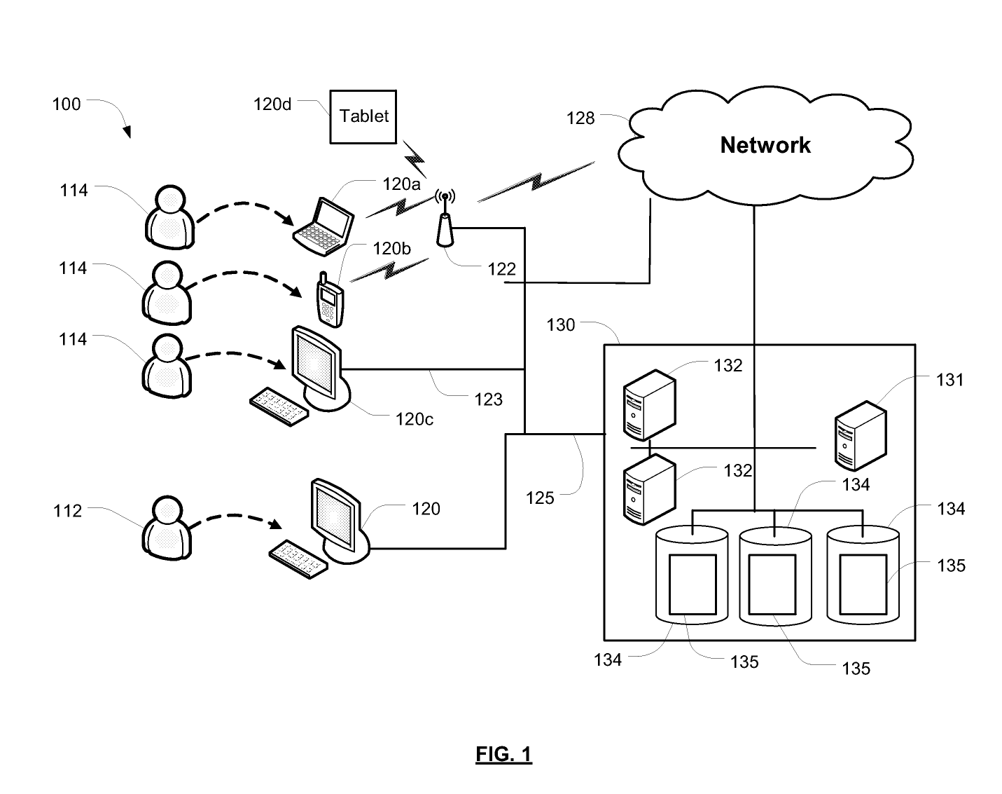

Turning now to FIG. 1, illustrated therein is a system 100 for providing guided instructional design according to one embodiment.

Using the system 100, one or more users 112, 114 may communicate with an educational service provider 130 to participate in, create, and consume electronic learning services. The users 112, 114 may be individuals or user accounts associated with the users.

In some cases, the educational service provider 130 may be part of or associated with a traditional “bricks and mortar” educational institution (e.g. a grade school, university or college), another entity that provides educational services (e.g. a company that specializes in offering training courses, or an organization that has a training department), or may be an independent service provider (e.g. for individual electronic learning).

The users 112, 114 may consume learning services. The users 112, 114 may not necessarily consume like learning services. For example, the user 112 may consume learning services provided to learners of one particular course, while users 114 may consume learning services provided to learners in another course.

The communication between the users 112, 114 and the educational service provider 130 can occur either directly or indirectly using any suitable computing device. For example, the user 112 may use a computing device 120 such as a desktop computer that has at least one input device (e.g. a keyboard and a mouse) and at least one output device (e.g. a display screen and speakers). The computing device 120 can generally be any other suitable device for facilitating communication between the users 112, 114 and the educational service provider 130. For example, the computing device 120 could be a laptop 120a wirelessly coupled to an access point 122 (e.g. a wireless router, a cellular communications tower, etc.), a wirelessly-enabled personal data smart phone 120b or table 120d, or a terminal 120c over a wired connection 123.

The computing devices 120 may be connected to the service provider 130 via any suitable communications channel. For example, the computing devices 120 may be communicate to the educational service provider 130 over a local area network (LAN) or intranet, or using an external network (e.g. by using a browser on the computing device 120 to browse to one or more web pages presented over the Internet 128).

In some examples, one or more of the users 112, 114 may be required to authenticate their identities in order to communicate with the educational service provider 130. For example, the users 112, 114 may be required to input a login name and/or a password to gain access to the services provided by the educational service provider 130.

In some embodiments, the wireless access points 122 may connect to the educational service provider 130 through a data connection 125 established over the LAN or intranet. Alternatively, the wireless access points 122 may be in communication with the educational service provider 130 via the Internet 128 or another external data communications network. For example, one user 114 may use a laptop 120a to browse to a webpage that displays elements of an electronic learning system.

The educational service provider 130 generally includes a number of functional components for facilitating the provision of electronic learning services. For example, the educational service provider 130 generally includes one or more processing devices 132 (e.g. servers), each having one or more processors. The processing devices 132 are configured to send information (e.g. web page content) to be displayed on one or more computing devices 120 in association with the electronic learning system 100. In some embodiments, the processing device 132 may be a computing device 120 (e.g. a laptop or personal computer).

The educational service provider 130 also generally includes one or more data storage devices 134 that are in communication with the processing devices 132 (e.g. servers), and could include a relational database, file system, or any other suitable data storage device. The data storage devices 134 are configured to host data 135 such as course content and enrollment information.

The data storage devices 134 may also be configured to store other information, such as personal information about the users 112, 114 of the system 110, information about which courses the users 112, 114 are enrolled in, roles to which the users 112, 114 are assigned in various contexts, particular interests of the users 112, 114 and so on.

The processing devices 132 and data storage devices 134 may also be configured to provide other electronic learning capabilities (e.g. allowing users to enroll in courses), and/or may be in communication with one or more other service providers that provide such other electronic learning capabilities.

In some embodiments, the system 100 may also have one or more backup servers 131 that may duplicate some or all of the data 135 stored on the data storage devices 134. The backup servers 131 may be desirable to prevent data loss in the event of an accident such as a fire, flooding, hardware failure, or theft.

In some embodiments, the backup servers 131 may be directly connected to the educational service provider 130 but located within the system 110 at a different physical location. For example, the backup servers 131 could be located at a remote storage location at a distance from the service provider 130, and the service provider 130 could connect to the backup server 131 using a secure communications protocol to ensure that the confidentiality of the data 135 is maintained.

Users, such as users 112, 114, may partake in a course, which involves course activities. As used here, “course” is a general term that can applied to formal courses offered through an educational institution such as a University, as well as any other type of program used for education, vocational training, apprenticeship or intern experience, self-study, etc. In other words, a “course” need not be limited to a credit-based offering by an educational institution, delivered by an employee of that institution.

Regardless of the type of course, a course can be thought of as involving at least one course activities. As used here, “course activity” refers to an activity or event that is scheduled or prescribed by a learning institution, and which pertains to a particular course. Some examples of course activities include, but are not limited to: final exams, midterm exams, in-class tests, class assignments, laboratory sessions, laboratory report submissions, field research, class projects, group projects, independent study projects, and papers such as theses, essays and creative writing.

Course activities may be characterized with respect to any of: type (e.g. final exam, midterm exam, in-class test, etc.); date (e.g. start date, due date, session date, etc.); duration; grades/marks (e.g. number of marks available, the percentage weight of the overall course grade, etc.); applicable course material (e.g. a midterm might cover particular pages of the course textbook). Any particular course activity may be characterized by other characteristics not listed here.

Course activities may be directly evaluated for grades (such as exams, tests, assignments), or indirectly evaluated for grades (such as an un-graded exercise or an un-graded laboratory session).

When a student is subject to more than one course activity, then a proximity between the dates of two course activities can be defined. For example, an assignment in one course may have a due date of September 26^{th}, and an assignment in another course may have a due date of September 28^{th}. In such a case, the proximity between the two course activities is two days.

In some cases, certain course activities may be “choice-of-outcome” course activity, such as a project for which the student can select a topic. The topic might be connected to a particular learning outcome.

Course activities with similar learning outcomes may form a collection known as an “activity stream”. For example, a midterm exam in one course may cover topics that overlap with the midterm exam in another course, such that there is a shared learning outcome between the two midterm exams. In such a case, the two midterm exams could be connected in a common activity stream. According to some embodiments, an activity stream may be defined by a single course activity.

In addition to course activities, students may also partake in “pacing activities”. Pacing activities are supplemental activities (i.e. in addition to “course activities”) that a student can undertake in pursuit of a learning outcome. For example, pacing activities can include various study activities and study sessions. Pacing activities can be defined in terms of the resources pertaining to the pacing activity (e.g. course resources and supplemental resources), as well as the time or duration of the pacing activity.

collection of pacing activities forms a “pacing guide”. For example, pacing activity PA1 may involve reading a particular section of material from course resources or supplemental resources. Pacing activity PA2 may involve practice exercises that pertain to the material read during PA1. Pacing activity PA3 may involve reading a new section of material, which may pertain to a more in-depth study of the material read during PA1. Alternatively, PA3 may involve a mock test or examination, or any other type of activity.

Generally speaking, a pacing guide can be characterized with respect to the number of pacing activities in the pacing guide, the duration of time allotted (e.g. four one-hour sessions would have a total duration of four hours), the period of the pacing guide (e.g. four sessions spread over two weeks would have a period of two weeks), the learning outcome associated with the pacing guide, and, optionally, a course activity for which the pacing guide is derived. There is no requirement for a pacing guide to be composed of a particular number or type of pacing activities.

Once an activity stream and a pacing guide have both been established, they can be merged to form a “personal learning stream”. As such, the personal learning stream includes both pacing activities as well as course activities within the same stream. However, it is not necessary that a personal learning stream include both a pacing activities and course activities. For example, if a pacing guide is not being used, or is unavailable, then “personal learning stream” is synonymous with “activity stream”. Similarly, if an activity stream is not being used, or is unavailable, then “personal learning stream” is synonymous with “pacing guide”. In the event that the activity stream and pacing guide are merged, then the merged stream may be referred to as a “personal learning stream”.

In some cases, particular resources or materials may be assigned or required in order to complete a course. These are referred to as “course resources”. For example, if the course is Biology 210, and the required textbook is “Fundamentals of Anatomy and Physiology”, then it can be said that “Fundamentals of Anatomy and Physiology” is a course resource. A course resource may also pertain to a course activity. For example, a particular chapter of “Fundamentals of Anatomy and Physiology” may be assigned by an instructor as required reading in conjunction with a particular test or assignment. Other examples of course resources include handouts and presentations provided by an instructor, a student's notes taken during a lecture or class, and the lecture material itself.

In addition to course resources, a student may use supplemental resources. “Supplemental resources” refers to resources other than course resources, which may assist the student, or be used with pacing activities. For example, supplemental resources may include resources suggested by a course instructor (though not necessarily mandatory), third-party resources, resources provided by a third-party tutor, and the course resources from other courses that the student is currently taking, or has taken (e.g. a pre-requisite course).

According to some embodiments, the likelihood or expectation that a student will be able to achieve success in a particular endeavor can be determined or estimated. This is called a “learner proficiency” or “learner proficiency score”. In particular, learner proficiency can be stated in respect of a particular learning outcome, or group of learning outcomes.

Learner proficiency can be derived by various means, including, but not limited to, a student's past performance in similar endeavors (e.g. towards a similar learning outcome), a student's general aptitude, etc. [need to cross-reference with a more global definition; e.g. in other applications].

A learner proficiency score represents a learner proficiency in a qualitative or quantitative manner. Generally speaking, regardless of the particular scoring system used, a low learner proficiency score indicates that a student lacks proficiency towards a particular learning outcome, and a high learner proficiency score indicates that a student has high proficiency towards a particular learning outcome. For example, a learner proficiency score may be provided on a numerical scale of 1 to 10, where 1 indicates the lowest score, and 10 indicates the highest score. In another example, a learner proficiency score may be provided on an alphabetic sale of A to E, where A is the highest proficiency, and E is the lowest.

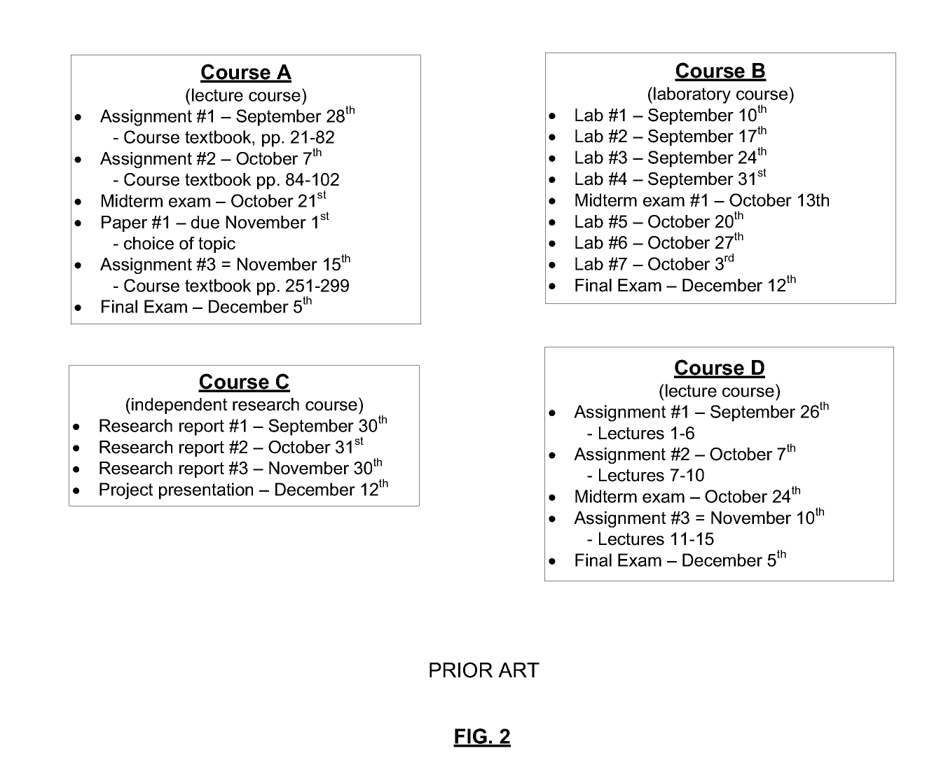

An example of a typical course activity schedule is shown for four different courses in FIG. 2. In the example, course activities are shown for Course A, Course B, Course C, and Course D, though, in general no particular number of courses is required.

Course A is deemed a “lecture course”, which, in this example, indicates that the course format comprises lectures, a midterm exam, and a final exam. Three assignments are included in the course, as well as a paper.

Each course activity can be characterized in terms of type, dates, duration, grades/marks, applicable course material, etc. For example, in Course A, Assignment 1 is of the “assignment” type, and has a due-date of September 28^{th} which, in this example, means that the assignment is due for submission in class on September 28^{th}. The duration of Assignment #1, in this example, is not fixed, since a student can take as long as is necessary to complete the assignment prior to the due-date.

The format of Course A has been specified such that all assignments are worth 5% of the overall grade. Each assignment is marked out of 10 marks (thus, each mark on an assignment is worth 0.5% of the overall grade for Course A). In other words, Assignment #1 is directly evaluated, and the grade-weight for Assignment #1 Course A is 5%. The grade-weights for the Course A course activities, in general, are:

assignments are worth 5% each; the paper is worth 10%; the midterm exam is worth 25%; and the final exam is worth 50%. In the example of Course A, all course activities are directly evaluated.

As indicated, Assignment #1 in Course A will be based on pages 21 to 82 of the prescribed course textbook. This defines the applicable course material in the example of Assignment #1 in Course A.

A similar breakdown of the course activities for Course B, Course C, and Course D can be done. Course B is comprised seven laboratory session with accompanying laboratory reports. There is no mark for a laboratory session, per se—other than a “pass/fail” grade, which makes the laboratory sessions mandatory.

However, a laboratory report for each laboratory session is due at the start of the next week's laboratory session. The grade-weight of each laboratory report is 5%. Thus, the laboratory sessions, themselves, are indirectly evaluated, and the laboratory reports are directly evaluated. The grade-weight of the midterm exam in Course B is 15%, and the final exam is worth 50% of the overall grade.

Course C is somewhat unique, in that it is an independent study course. In Course C, a student may choose a topic for the independent study, with the approval of supervising faculty. There is only one directly-evaluate course activity for Course C, which is the final project presentation. Thus, the grade-weight of the project presentation is 100%. Throughout Course C, there are three research reports that the student must submit to the supervising faculty. There is no direct evaluation of these research reports; but, if the supervising faculty does not see sufficient progress in the student's learning through each report, then remedial measures may be required; and, ultimately, the grades accumulated in the project presentation may be in jeopardy.

According to the systems and methods disclosed herein, a course activity can also have at least one associated learning outcome. For example, the learning outcome for an assignment might be “solving homogeneous first-order differential equations”. A course activity may have more than one associated learning outcome; and there is no limit to the number of learning outcomes that may be associated with a course activity.

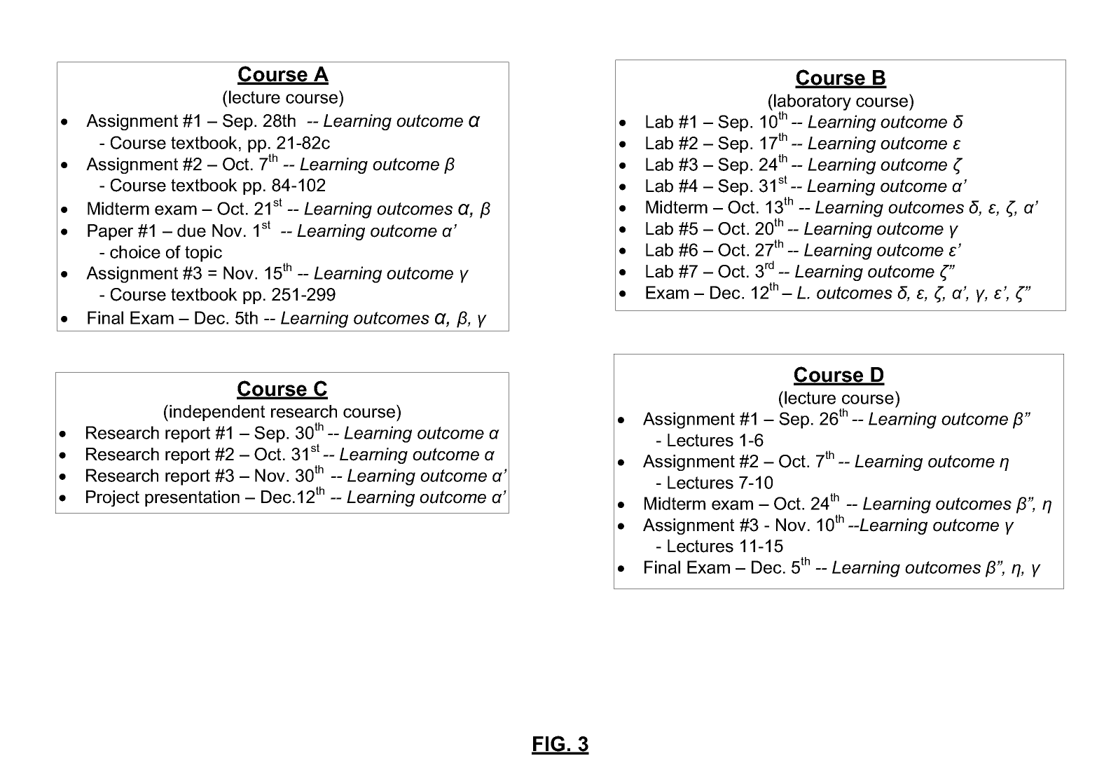

An example of associations between course activities and learning outcomes if show in FIG. 3. As can be seen in the example, Assignment #1 in Course A is associated with learning objective α. Assignment #2 in Course A is associated with learning objective β. The midterm exam in Course A is associated with learning objectives α and β, since the midterm exam covers the course material up to October 21^{st}, which includes the same material as Assignment #1 and Assignment #2.

In the examples provided, and as described herein, a single learning objective is associated with most course activities, and multiple learning objectives are associated with some course activities such as midterm exams and final exams. However, it is to be appreciated that, in many cases, there will be multiple learning objectives associated with course activities, and not just a single learning objective.

For example, the laboratory session Lab #1 in Course B may have learning objective δ. If Course B is a course in electronics, then learning objective δ may relate to designing a particular type of electronic circuit. However, there may be other related learning objectives, such as how to properly follow laboratory procedures, how to maintain a laboratory journal, soldering technique, etc. Nonetheless, in the interest of simplicity and clarity of illustration of the present description, the examples provided may indicate a single learning objective.

As can be seen in FIG. 3, it is possible that multiple course activities may be associated with similar learning outcomes. In some cases, “similar” may mean “essentially or substantially the same”. For example, Assignment #3 in Course A, Lab #5 in Course B, and Assignment #3 in Course D are all associated with learning objective γ.

In other cases, “similar” may mean “somewhat the same, but with some variance”. For example, Assignment #1 in Course A is associated with learning outcome α, and Lab #4 is associated with learning outcome α′. In the examples of FIG. 3, the prime character (the single quote ′) is used to indicate a relatively minor difference between learning outcome α and learning outcome α′. For example, learning outcome α may relate to solving homogeneous first-order differential equations, and learning outcome α′ may relate to the solving of homogeneous first-order differential equations with respect to designing and implementing particular types of electronic circuits.

The fact that some learning outcomes may be similar to other learning outcomes means that different learning outcomes can be expressed due to their relative degree of similarity. For example, Assignment #1 in Course A is associated with learning outcome α, and Research Report #1 in Course C is associated with learning outcome α. Therefore, there is a very high degree of similarity between these two learning outcomes (i.e. they are essentially the same).

However, the degree of similarity between two learning outcomes may be less than very high (essentially the same). For example, Assignment #1 in Course A is associated with learning outcome α, and Lab #4 of Course B is associated with learning outcome α′, which is slightly different than, but related to learning outcome α.

Furthermore, the degree of similarity between two learning outcomes may be even less. For example, Assignment #2 in Course A is associated with learning outcome β, and Assignment #1 of Course D is associated with learning outcome β″. In this case, the degree of similarity between β and β″ is less than the degree of similarity between α and α′.

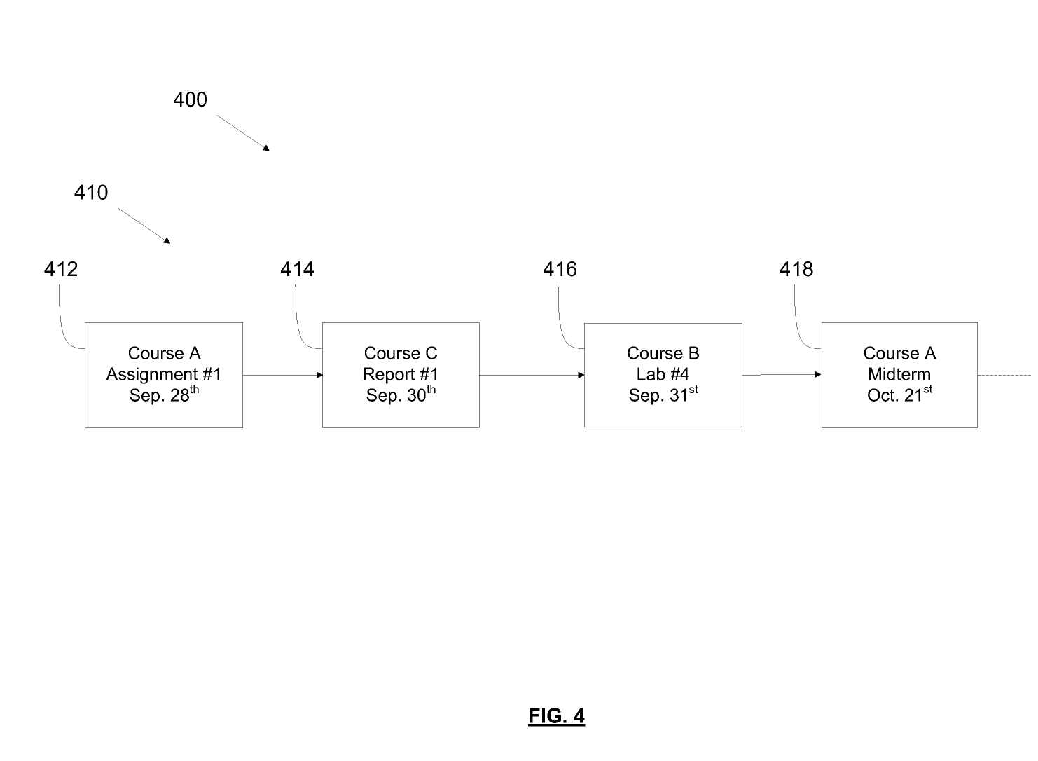

Referring to FIG. 4, there is shown a student learning stream 400 and an activity stream 410. The activity stream 410 is comprised of course activities that have been joined together. In the example shown, course activity 412 (Course A, Assignment #1) is joined to course activities 414, 416, and 418 (Course C, Report #1; Course B, Lab #4; and Course B, midterm, respectively). Each of the course activities 412, 414, 416, and 418, are sequentially ordered by date.

Student learning stream 400 and activity stream 410, in the example shown, can be said to relate to learning outcome α (in reference to FIG. 3). The focus, or primary course activity for student learning stream 400 and activity stream 410, as shown, is the midterm exam in Course A, which his on October 21^{st}. Since one of the learning outcomes associated with the midterm in Course A is learning outcome α, the activity stream 410 includes other course activities, from other courses, all of which are associated with learning outcome α.

The activity stream can include course activities based on the degree of similarity between learning outcomes. For the purposes of example activity stream 410, learning outcome α′ has been determined to be of a sufficiently-high degree of similarity to learning outcome α such that Lab #4 in Course B is included in the learning-outcome-α activity stream towards the midterm of Course A.

However, another example could be derived, in which the degree of similarity between two learning outcomes was not sufficient for a course activity to be included in the activity stream. For example, for a particular case, if learning outcome β″ is not of a sufficiently-high degree of similarity to learning outcome β, then Assignment #1 of Course D would not be included in an activity stream towards the midterm of Course A.

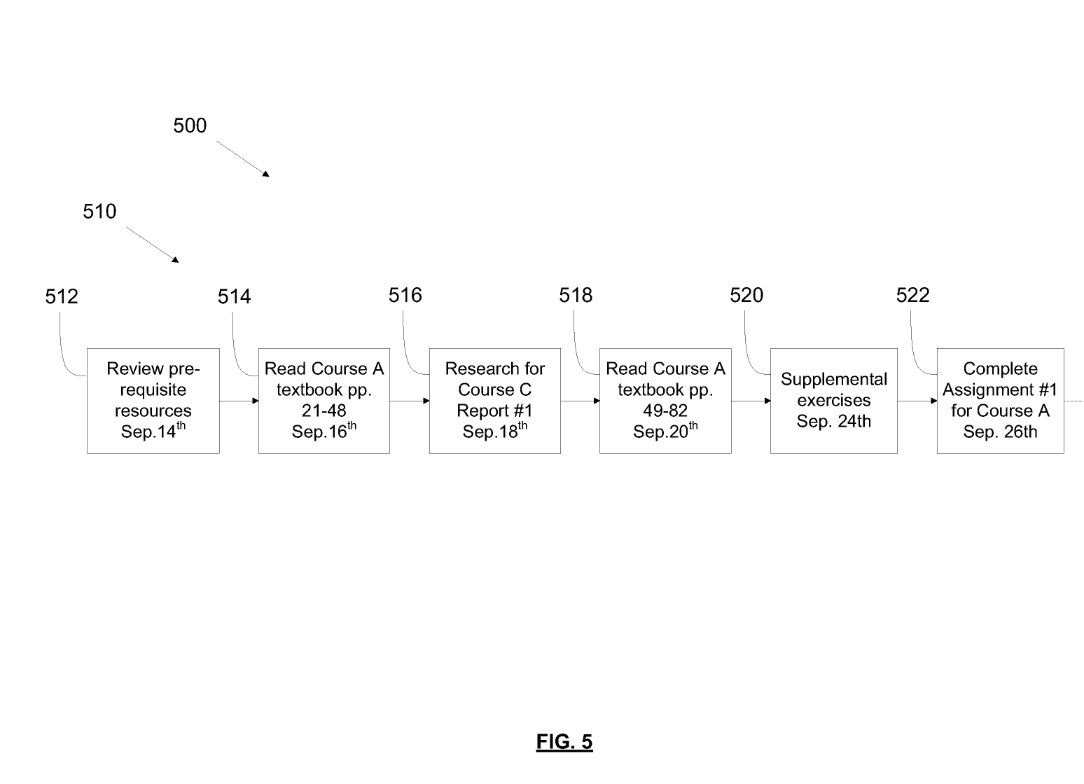

Referring to FIG. 5, there is shown a student learning stream 500 and a pacing guide 510. The pacing guide 510 is comprised of pacing activities that have been joined together. In the example shown, pacing activity 512 (review pre-requisite resources) is joined to pacing activities 514, 516, 518, 520, and 522. Each of the pacing activities is sequentially ordered by date.

Student learning stream 500 and pacing guide 510 can be said to relate to learning outcome α (in reference to FIG. 3). The focus, or primary course activity for student learning stream 500 is Assignment #1 in Course A, which is due to be submitted on September 26^{th}. Since Assignment #1 in Course A is associated with learning outcome α, the pacing guide 510 includes pacing activities (512, 514, 516, 518, 520, and 522) that are also associated with learning outcome α.

As with the course activities in an activity stream, the pacing activities in a pacing guide can be determined based on the degree of similarity between learning outcomes.

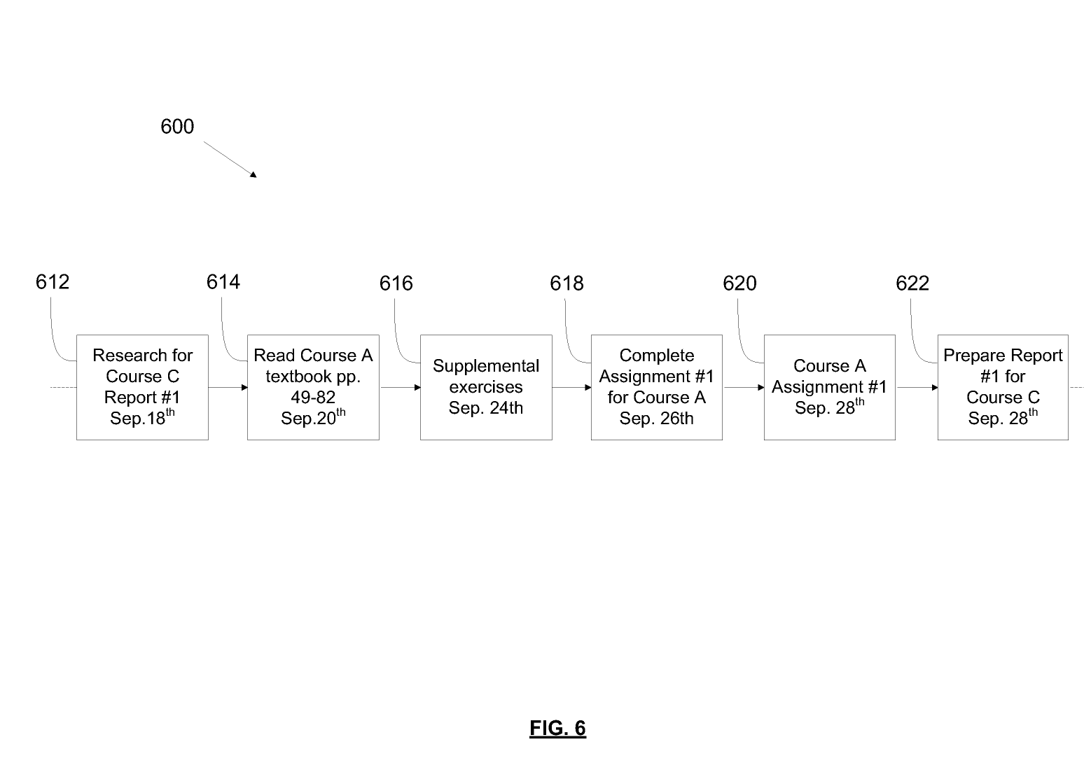

Referring to FIG. 6, there is shown a student learning stream 600 that comprises an activity stream merged with a pacing guide. The student learning stream 600 comprises pacing activities 612, 614, 616, 618, and 622, as well as course activity 620.

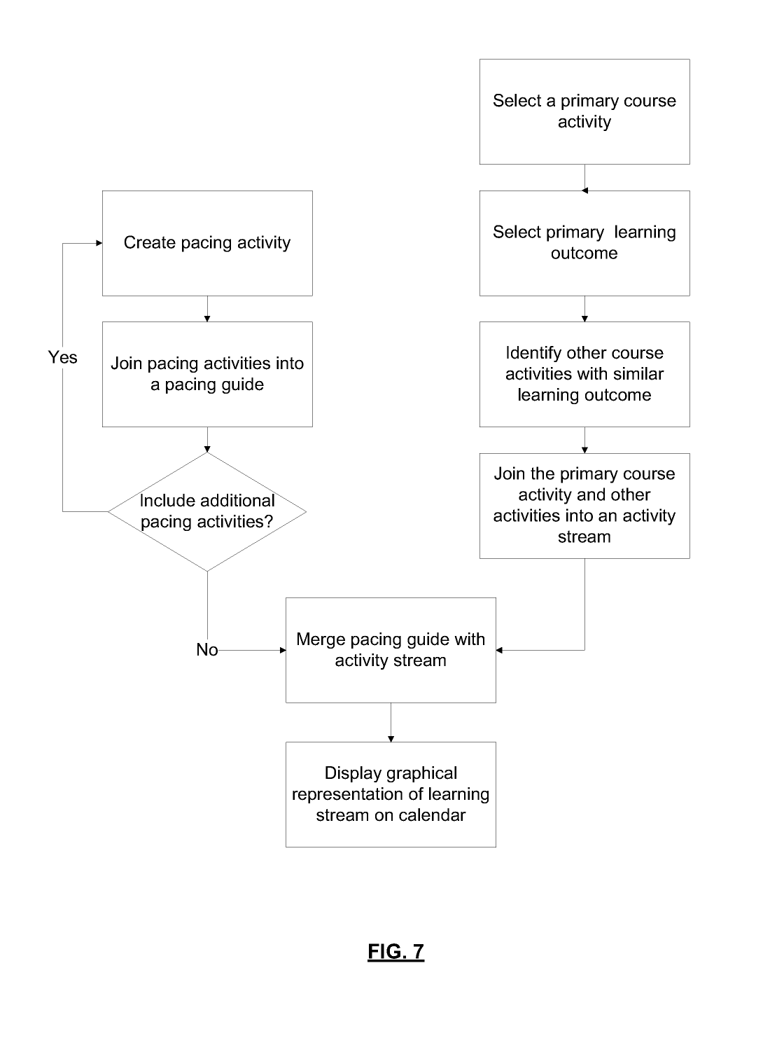

Referring to FIG. 7, there is shown a method for collating course activities from a plurality of courses into a person a learning stream.

A step 710, a primary course activity is selected. For example, as in FIG. 4, the primary course activity is the midterm in Course A. One way to understand the concept of an activity stream is to ask “what needs to get done?” with respect to the primary course activity.

The primary course activity may be selected by a student. For example, a student may decide to use the system to construct a personal learning stream in relation to a particular course activity. In some embodiments, a primary course activity may be automatically selected by the system, or determined by the learning institution or course instructors.

According to other embodiments, every course activity may be used as a primary course activity. In other words, if a course includes five different course activities, then the system may automatically generate a student learning stream for each course activity (thus there would be five student learning streams automatically generated). In some embodiments, a default, or skeletal student learning stream may be automatically generated, which can then be further adjusted based on the input of a human user. In other embodiments, a student learning stream may be automatically generated that is customized for the particular student, based on, for example, a student's learner proficiency with respect to the learning outcome, the grade-weight of the course activity, the proximity of the course activity to other activities (other course activities and pacing activities), etc.

At step 712, a primary learning outcome associated with the primary course activity is selected. For example, as in FIG. 4, if the primary course activity is the midterm in Course A, then learning outcome α may be selected. (As described elsewhere, there may be other learning outcomes associated with the midterm in Course A, but only learning outcome α is shown is FIG. 3, for the sake of simplicity of explanation). The selected learning outcome can be deemed the primary learning outcome with respect to the student learning stream.

Once the primary learning outcome has been selected, then, at step 714, other course activities with a similar learning outcome are identified. Again, turning to the examples of FIG. 3 and FIG. 4, if the primary learning outcome is learning outcome α, then other course activities with a similar learning outcome are: Assignment #1 in Course A; Report #1 in Course C; and Lab #4 in Course B.

In FIG. 4, Lab #4 in Course B is included in the student learning stream, since the learning outcome α′ is deemed to be of sufficiently-high similarity to learning outcome α so as to be included.

Paper #1 of Course A, the Final Exam of Course A, Research Reports #2 and #3 of Course C, etc., are also associated with learning outcome α or learning outcome α′. However, they are not included in the example student learning stream of

FIG. 4, since each course activity has a relevant date that is after the date of the primary course activity, which, in the example, is the midterm in Course A on October 21^{st}.

At step 716, the other course activities (which were identified at step 714) are joined tougher with the primary course activity, in order to form an activity stream.

At step 718, a pacing activity is created. The pacing activity may be created by a human user, such as a student. The pacing activity may be created automatically by the system. The pacing activity may also be created by a human user with assistance or suggestion from the system.

At step 720, the pacing activity created at step 718 is joined to the pacing guide. After the first execution of step 718, there will be no other pacing activities in the pacing guide to which the pacing activity can be joined.

At step 722, if additional pacing activities are to be included in the pacing guide, then the method returns to step 718, and proceeds through step 720. If there are no more pacing activities to be included, then the method proceeds to step 724.

At step 724, the pacing guide and activity stream are merged in order to form a single student learning stream. In some cases, there may be no pacing guide (i.e. the pacing guide does not include any pacing activities). In such a case, the student learning stream will be comprised solely of the activity stream. In other cases, there may be no activity stream (i.e. the activity stream does not include any course activities). This may be the case, for example, if a student wants to brush up on some fundamental skills on his or her own initiative, independent of any particular course. In such a case, the student learning stream will be comprised solely of the pacing guide.

At step 726, the student learning stream is displayed graphically on a calendar.

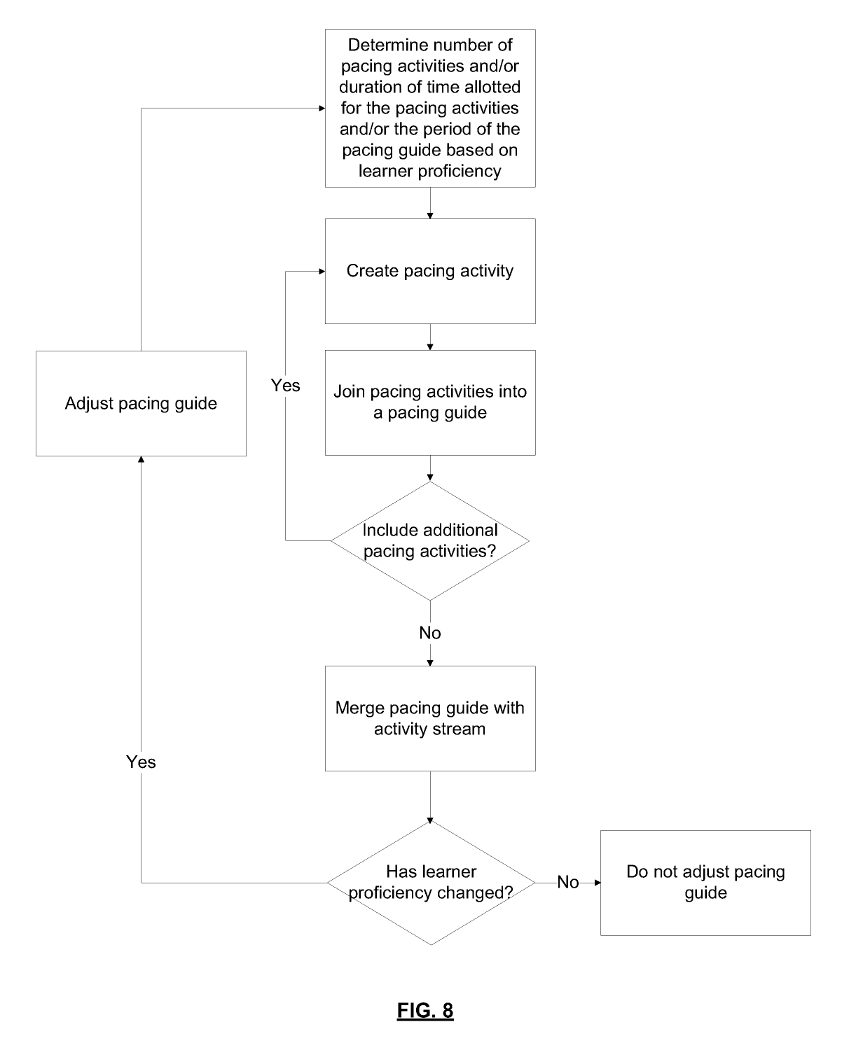

Referring to FIG. 8, there is shown a method for collating course activities from a plurality of courses into a personal learning stream.

At step 810, the student's learner proficiency is used to determine any or all of the number of pacing activities, the duration of time allotted for the pacing activities, and the period of the pacing guide.

According to some embodiments, the number of pacing activities may be determined based on learner proficiency. This determination may be made by a human user (e.g. a student), automatically by the system, or by a human user with the assistance of the system. For example, if a student has a low learner proficiency with respect to a learning outcome, then it may be desirable to include more pacing activities in the pacing guide so that the student can improve his or her learning.

Alternatively, in some cases, if a student lacks proficiency towards a particular learning outcome, and if, for example, the learning outcome or associated course is not important to the student, then fewer pacing activities may be included so that the student does not waste his or her time struggling on something that is of relatively little importance.

According to some embodiments, the time allotted for the pacing activities may be determined based on learner proficiency. For example, if a student is highly proficient towards a particular learning outcome, then two one-hour study sessions may be sufficient to achieve a desired outcome. However, if a student lacks proficiency towards a particular learning outcome, then two three-hour session may be more appropriate.

According to some embodiments, the period of the pacing guide may also be determined based on learner proficiency. For example, if a student is highly proficient towards a particular learning outcome, then he or she may not need to start studying until a few days before a midterm, which may make more time available towards pursuing other learning outcomes. However, if a student lack proficiency towards a particular learning outcome, then he or she may be better off by starting to study a month before the midterm.

The method proceeds through steps 812 to 818 as previously described for steps 718-724. However, in the method shown in FIG. 8, the determinations made in step 810 inform the procedure through steps 812 to 818.

At step 820, the method can check to see if learner proficiency has changed. In the case of a student learning stream with many activities, an improvement in learner proficiency may be used to alter the student learning stream going forward. For example, a student learning stream that prepares a student for a midterm may use a learner proficiency score of 5 out of 10 to determine that study sessions should be 2 hours long. However, if, after the midterm, the student improves his or her learner proficiency score to 8 out of 10, then the method may determine that study sessions of 1 hour are sufficient to achieve the desired results.

If the learner proficiency has not changed, or, if the particular embodiment does not include the capabilities to adjust the pacing guide, then the method continues to step 824, and the pacing guide is not adjusted.

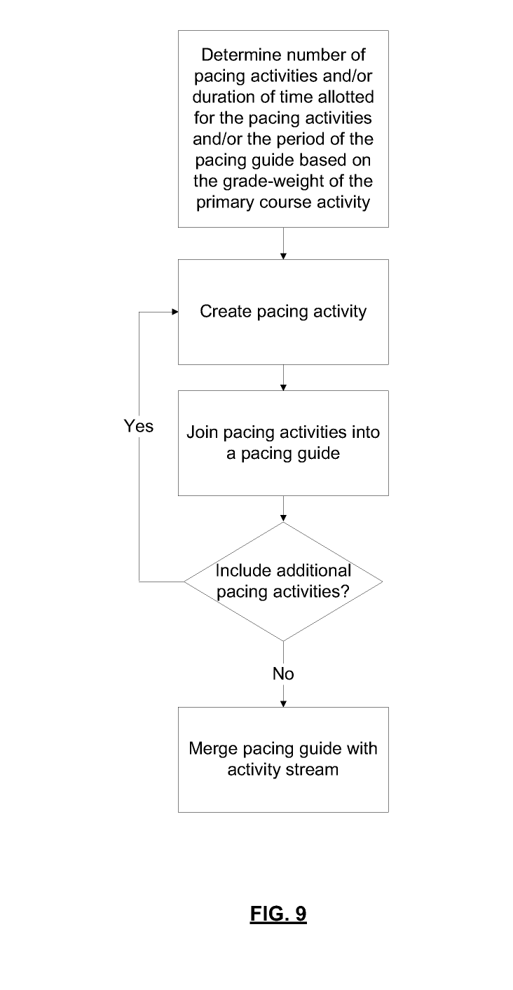

Referring to FIG. 9, there is shown a method for collating course activities from a plurality of courses into a personal learning stream.

At step 910, the grade-weight of the primary course activity is used to determine any or all of the number of pacing activities, the duration of time allotted for the pacing activities, and the period of the pacing guide.

According to some embodiments, the number of pacing activities may be determined based on the grade-weight of the primary activity. This determination may be made by a human user (e.g. a student), automatically by the system, or by a human user with the assistance of the system. For example, if a course activity has a high grade-weight, then it may be desirable to include more pacing activities in the pacing guide.

According to some embodiments, the time allotted for the pacing activities may be determined based on the grade-weight of the primary course activity. For example, if an assignment is worth 5% of the overall course grade, then two one-hour study sessions may be sufficient to achieve a desired outcome. However, if a midterm is worth 25% of the overall course grade, then two three-hour sessions may be more appropriate.

According to some embodiments, the period of the pacing guide may also be determined based on the grade-weight of the primary course activity. For example, if an assignment is worth 5% of the overall course grade, then a student may not need to start studying until a few days before the assignment is to be completed, which may make more time available towards pursuing other learning outcomes. However, if a final exam is worth 50% of the overall course grade, then the student may be better off by starting to study a month before the exam.

The method proceeds through steps 912 to 918 as previously described for steps 718-724 in FIG. 7. However, in the method shown in FIG. 9, the determinations made in step 910 inform the procedure through steps 912 to 918.

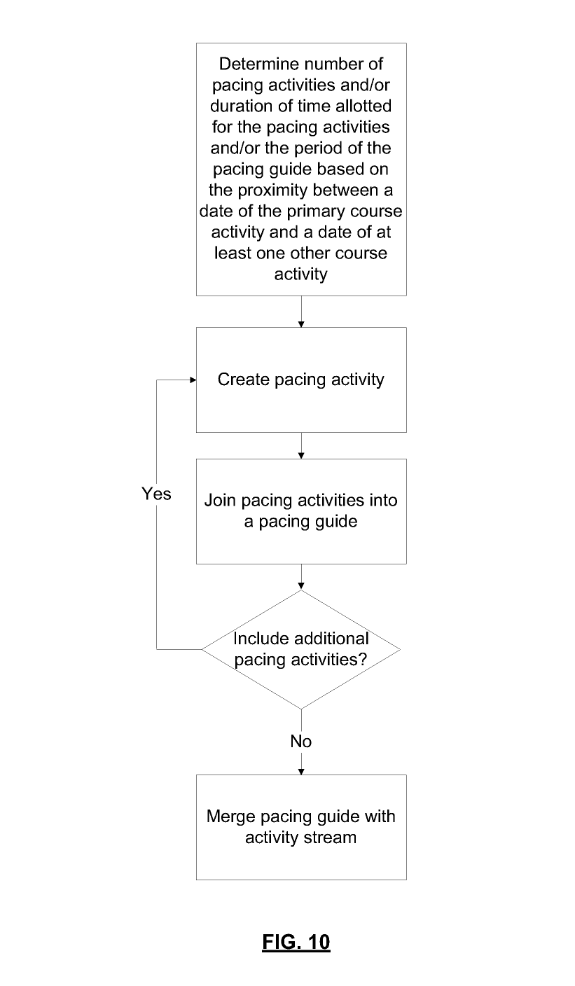

Referring to FIG. 10, there is shown a method for collating course activities from a plurality of courses into a personal learning stream.

At step 1010, the proximity of the primary course activity to other activities is used to determine any or all of the number of pacing activities, the duration of time allotted for the pacing activities, and the period of the pacing guide.

According to some embodiments, the number of pacing activities may be determined based on the proximity of the primary activity to other activities in the student learning stream. This determination may be made by a human user (e.g. a student), automatically by the system, or by a human user with the assistance of the system. For example, if a course activity is within close proximity to other course activities in the student learning stream, then it may be desirable to include fewer pacing activities in the pacing guide between these two course activities. If a student is well-prepared for a particular course activity, then it may not be a good use of time for that student to put significant effort into preparing for another course activity with a similar learning outcome as the first.

According to some embodiments, the time allotted for the pacing activities may be determined based on the proximity of the primary course activity to other activities in the student learning stream. For example, if an assignment occurs two days after another course activity in the student learning stream, then one-hour study session may be sufficient to achieve a desired outcome. However, if a final exam occurs two months after any other course activities in the student learning stream, then two three-hour sessions may be more appropriate.

The method proceeds through steps 1012 to 1018 as previously described for steps 718-724 in FIG. 7. However, in the method shown in FIG. 10, the determinations made in step 1010 inform the procedure through steps 1012 to 1018.

The above examples and descriptions using a primary course activity represent some embodiments. However, they are also used for the purpose of explanation. According to some embodiments, it is possible to build a continues student learning stream for a particular learning outcome. From one perspective, this can be thought of as a single student learning stream for which the course activity with the latest date is the primary course activity. From another perspective, this can be thought of as a series of cascading student learning streams, each with its own primary course activity. For example: a midterm exam may be a primary course activity, for which a specific student learning stream can be generated. Nonetheless, a final exam may serve as a primary course activity, for which that same midterm exam is another course activity that aids in preparation for the final exam.

While the above description provides examples of one or more apparatus, methods, or systems, it will be appreciated that other apparatus, methods, or systems may be within the scope of the claims as interpreted by one of skill in the art.

1. A method for collating course activities from a plurality of courses into a personal learning stream, comprising:
a) selecting a primary course activity associated with a primary course within the plurality of courses;
b) selecting a primary learning outcome associated with the primary course activity;
c) identifying other course activities that are associated with a learning outcome similar to the primary learning outcome, the other course activities being associated with courses within the plurality of courses; and,
d) joining the primary course activity and other course activities into an activity stream.

2. The method of claim 1, further comprising:
e) creating a pacing guide from at least one pacing activity, the at least one pacing activity being associated with the primary learning outcome; and,
f) merging the pacing guide with the activity stream.

3. The method of claim 2, wherein no other course activities are identified and no other course activities are joined with the primary course activity into the activity stream.

4. The method of claim 2, wherein at least one of:
the number of pacing activities;
the duration of time allotted for the pacing activities; and,
the period of the pacing guide;
is determined by a learner proficiency score associated with the primary learning outcome.

5. The method of claim 0, wherein at least one of:
the number of pacing activities;
the duration of time allotted for the pacing activities; and,
the period of the pacing guide;
is determined proportionally to the learner proficiency score associated with the primary learning outcome.

6. The method of claim 2, wherein at least one of:
the number of pacing activities;
the duration of time allotted for the pacing activities; and,
the period of the pacing guide;
is determined by a grade-weight associated with the primary course activity.

7. The method of claim 2, wherein at least one of:
the number of pacing activities;
the duration of time allotted for the pacing activities; and,
the period of the pacing guide;
is determined by a proximity between a date of the primary course activity and a date of at least one of the other course activities.

8. The method of claim 1, wherein resources associated with the other course activities are listed together with resources associated with the primary course activity.

9. The method of claim 2, wherein resources associated with the at least one pacing activity are listed together with resources associated with the primary course activity.

10. The method of claim 1, wherein the personal learning stream is graphically represented on a calendar.

11. The method of claim 2, wherein the personal learning stream is graphically represented on a calendar.

12. An electronic learning system for collating course activities from a plurality of courses into a personal learning stream, the system comprising:
a) a display; and,
b) at least one processor operatively coupled to the display, the at least one processor configured for:
i) selecting a primary course activity associated with a primary course within the plurality of courses;
ii) selecting a primary learning outcome associated with the primary course activity;
iii) identifying other course activities that are associated with a learning outcome similar to the primary learning outcome, the other course activities being associated with courses within the plurality of courses; and,
iv) joining the primary course activity and other course activities into an activity stream.

13. The system of claim 12, wherein the processor is further configured for:
v) creating a pacing guide from at least one pacing activity, the at least one pacing activity being associated with the primary learning outcome; and,
vi) merging the pacing guide with the activity stream.

14. The system of claim 13, wherein no other course activities are identified and no other course activities are joined with the primary course activity into the activity stream.

15. The system of claim 13, wherein at least one of:
the number of pacing activities;
the duration of time allotted for the pacing activities; and,
the period of the pacing guide;
is determined by a learner proficiency score associated with the primary learning outcome.

16. The system of claim 15, wherein at least one of:
the number of pacing activities;
the duration of time allotted for the pacing activities; and,
the period of the pacing guide;
is determined proportionally to the learner proficiency score associated with the primary learning outcome.

17. The system of claim 13, wherein at least one of:
the number of pacing activities;
the duration of time allotted for the pacing activities; and,
the period of the pacing guide;
is determined by a grade-weight associated with the primary course activity.

18. The system of claim 13, wherein at least one of:
the number of pacing activities;
the duration of time allotted for the pacing activities; and,
the period of the pacing guide;
is determined by a proximity between a date of the primary course activity and a date of at least one of the other course activities.

19. The system of claim 12, wherein the resources associated with the other course activities are listed together with resources associated with the primary course activity.

20. The system of claim 13, where resources associated with the at least one pacing activity are listed together with resources associated with the primary course activity.
